(19) United States
(12) Patent Application Publication
(10) Pub. No.: US 2004/0064734 A1
(43) Pub. Date: Apr. 1, 2004

(54) Electronic message system

(76) Inventor: Julian Ehrlich, Randwick (AU)

Correspondence Address: Gordon & Jacobson, P.C., 65 Woods End Road, Stamford, CT, 06905, US

(21) Appl. No.: 10/609,914

(22) Filed: Jun. 30, 2003

(30) Foreign Application Priority Data
Jun. 28, 2002 (AU) PS3246

(51) Int. Cl. H04L 9/32; G06F 15/173

(52) U.S. Cl. 713/201; 709/225

(57) ABSTRACT

The present invention is a method of processing a message addressed to a user address of a user, said message being transmitted through a communication network, including the steps of receiving the message at a message processor; said message processor checking for a valid authorization tag issued to the message; if the message has a valid authorization tag, said message processor transmitting the message through the network to the user; if the message does not have a valid authorization tag, delaying transmission of the message until verification of the message is conducted. The invention also provides a method of classifying an incoming message addressed to a user address into one of a plurality of pre-defined classes including the steps of storing user data including a plurality of said user addresses associated with said user, each said user address being further associated with one or more correspondents of said user, reading sender identification data associated with the incoming message, comparing said sender identification data to said user data to yield a comparison result, and classifying, in response to said comparison result, the incoming message as a member of one of said pre-defined classes of messages.

### BACKGROUND OF THE INVENTION

1. Technical Field

The present invention relates to an improved model of electronic communication services and in particular eliminating unsolicited messages. The invention is described primarily with reference to electronic mail services, where the problem of unsolicited messages (“spam”) is greatest, but the invention has application also to other forms of electronic communication such as short message service (SMS), instant messaging, pagers and telephone communications.

Further, the invention is described primarily in the context of computer server-to-computer server architectures which is the common network topology for electronic mail services, but the invention has application also to other network topologies involving single server, different combinations of peers and servers, and broader switching and routing of messages. The functions of a server can be performed by one machine, logical divisions of that one machine's resources, and/or shared a number of machines.

2. Related Art

The traditional model of e-mail services presents two broad problems:

there is an enormous cost to all concerned (ISP, intermediate proxy, accessed server, the end-user) from receiving bulk, unwanted messages;

the end-user has little opportunity to exercise control over the content of e-mail messages in his/her mailbox.

In particular, every time an end-user discloses his/her e-mail address in response to an on-line request, he/she loses all control over how the address is used. There is no effective method to prevent someone from e-mailing that individual. In most cases, the sender of an unsolicited message uses forged headers, sends the message through a proxy server or uses dynamic IP address to prevent the end-user from identifying the sender of the message.

In an effort to eliminate unsolicited messages, the prior art teaches an approach of filtering an e-mail message by examining the message headers and the message content and comparing them to a set of rules. Sometimes, the rules are created by the ISP, sometimes the rules are provided by the user, and sometimes the rules are provided by a third party.

Filtering systems run the risk of false positives (classifying a message as unwanted when it is wanted) and false negatives (determining that a message is wanted when it is not).

The prior art also includes the use of multiple e-mail addresses (ie. revocable/disposable addresses, e-mail aliases, etc.) instead of the real e-mail address. All electronic messages that are sent to any of disposable e-mail addresses are automatically forwarded to the real e-mail address. The basic principle behind revocable/disposable addresses and e-mail aliases is e-mail forwarding, ie. service that allows a user to divert his/her e-mail to another e-mail account.

Such an approach does not evaluate whether an e-mail message is wanted or unwanted based on content. If the alias address is active, the e-mail is delivered, if the alias address is off, the e-mail is rejected.

If the user receives unwanted e-mail through a disposable e-mail address, the user can turn off that particular e-mail address without affecting any other disposable e-mail addresses.

The main disadvantage of disposable e-mail addresses is that they do not stop the unwanted messages. A disposable address must be abused at least once, before it will be blocked. The user is required to look through all e-mail messages forwarded to his/her e-mail address to determine the source of the unwanted e-mail. As a result, the problem of spam is not solved but simply moved from one e-mail address to another. Furthermore, the user is required to maintain and check multiple e-mail addresses to determine which address was abused.

In addition, a real e-mail address will be revealed if a message sent to a disposable e-mail address is forwarded to someone else. Therefore, the user is prevented from using the ‘TO’, ‘CC’, ‘BCC’, ‘Reply All’, ‘Forward’ options when responding to an e-mail message that was sent to a disposable e-mail address. In other words, a disposable e-mail cannot be used as a fully functional ‘FROM’ address of the user without revealing the real e-mail address.

Further, the real e-mail address also can be revealed by legitimate e-mail the user sends that is forwarded to others, or from business cards or other directories where the user might list the address.

Generally, in order to send mail from an alias address, the user will need to temporarily reconfigure his/her e-mail client settings. For example, in Outlook Express, the user will need to change his/her ‘FROM’ address (and optionally his/her name) to reflect the alias mail address. The settings must be changed back to a regular e-mail address, or all of the user's mail will appear to come from the same alias address. This is a time-consuming operation.

There is nothing to prevent a user from having fully-functional multiple free e-mail accounts such as Yahoo/Hotmail instead of compromised disposable e-mail addresses. Such web-based e-mail when used through an anonymous proxy will not reveal the identity of the user. However, such an approach would require the user to remember multiple logins/passwords, and check multiple e-mail boxes.

The common problem of the existing spam-blocking tools such as dummy e-mail addresses and filtering e-mail according to sender or content is that they tend to gravitate towards the user side by performing spam eliminating functions close to the recipient of the unsolicited message. Some of the existing spam blocking techniques may be used to reject spam mail located in the user's mailbox without downloading the mail to the user's mail client. However, filtering POP protocols still allows spam mail to be stored on the STMP server. As a result, the existing tools do not reduce network traffic generated by spam e-mail. Further, they do not eliminate some other problems such as the use of network bandwidth, disk space, and system memory to store spam e-mail messages.

In addition, the range of terminals that receive mail has increased from PC to modern terminals such as Internet-to-wireless services using mobile phones, PDA, two-way pagers, etc. The incorporation of spam-eliminating devices on such terminals is highly problematic. The time to download a spam e-mail might be even higher due to the fact that the user is connecting through a mobile phone, or satellite phone connection. Both connections are quite expensive, with some being charged by the second. The existing spam blocking methods do not provide an effective solution to the problem of unsolicited e-mail, and particularly deficient in the context of Internet-to-wireless services.

Similar problems apply to other forms of electronic communications with similar structure where the user has a unique address (eg. a telephone number) which once known to a third party can become a target for unwanted communications.

The present invention aims to overcome one or more of these deficiencies of the prior art by providing a new method and system for electronic communications.

### SUMMARY OF THE INVENTION

A first form of the invention provides, in a communications network, a method of processing a message addressed to a user address, including the steps of:

receiving the message at a message processor;

said message processor checking for a valid authorization tag issued to the message;

if the message has a valid authorization tag, said message processor transmitting the message through the network to the user;

if the message does not have a valid authorization tag, delaying transmission of the message until verification of the message is conducted; and

if the message is verified, issuing an authorization tag to the message and said message processor transmitting the message through the network to the user; or if the message is not verified, not issuing an authorization tag to the message and said message processor not transmitting the message through the network to the user.

Preferably, said verification includes the step of verifying sender identification data against user address data of the message.

Preferably also, said message processor extracts said sender identification and user address data from the message and forwards said data to a verification processor to perform said verification. If the message is verified, the verification processor issues an authorization tag for the message, which is tagged to the message by the message processor.

Where said message is an electronic mail message, preferably, said message processor is a mail server and said verification processor is a verification server.

Desirably, the network includes a plurality of said mail servers enabled to perform said method, and a message transmission path of the message from the sender to the user address passes through two or more of said method-enabled mail servers. Thus, once a message is verified and issued with an authorization tag by performance of said method upon encountering a first said method-enabled server in the message transmission path, subsequent performances of the message by subsequent method-enabled mail servers in the message transmission path will detect the authorization tag and on-transmit the message without re-verification of the message.

Preferably, the authorization tag is a code which is tagged to the message. Preferably also, the authorization tag includes information identifying a user-specified address to which said message is to be forwarded.

A further form of the invention provides a method of classifying an incoming message addressed to a user address of a user into one of a plurality of pre-defined classes including the steps of

storing user data including a plurality of said user addresses associated with said user, each said user address being further associated with one or more correspondents of said user,

reading sender identification data associated with the incoming message, comparing said sender identification data to said user data to yield a comparison result, and

classifying, in response to said comparison result, the incoming message as a member of one of said pre-defined classes of messages.

Preferably, said method further includes the step of reading the user address associated with the incoming message, and preferably also comparing the sender identification data with said correspondents associated with said user address to which the message is addressed. Preferably, said classes include a first class of messages (“legitimate” messages) in which said comparison result identifies a match between a sender of the message and a correspondent associated with a live user address to which the message is addressed.

Preferably, if the message is classified into said first class of messages, said method further includes the step of transmitting the message through the computer network to said user associated with said user address. Preferably, said method further includes the step of distinguishing said legitimate messages in a pre-defined manner by tagging the message with an authorization tag as described above.

Preferably, said classes include a second class of messages (“quasi-legitimate” messages) in which said comparison result identifies a match between an aspect of the message and the user data.

Preferably said aspect of said message is an aspect of the sender identification data of the message.

Alternatively, said aspect of said message is an aspect of the user address of the message.

Preferably, if the message is classified into said second class of messages, said method further includes the steps of storing the message, notifying the user and seeking authorization for transmission of the message from the user. If the user grants said authorization, said method may further include the steps of distinguishing the message by tagging with an authorization tag and transmitting the message through the computer network to the user. If the user does not grant said authorization, said method may further include the step of deleting said message after a pre-determined time has elapsed. The method may further include the step of forwarding to the user (optionally, periodically), a list of such deleted messages.

Preferably said second class of messages includes a plurality of sub-classes, including one or more of the following sub-classes:

messages where the identity of the sender matches a correspondent associated with an expired user address to which the message is sent;

messages from a correspondent associated with a user address of said user, sent to a different user address of the user;

messages from a correspondent not associated with a user address of said user, sent to an address provided for the use of another correspondent, said both correspondents sharing message attributes that are acceptable to said user;

messages where the subject field of the message includes a correspondent associated with the user address; and

messages sent to a non-specific(‘general purpose’) user address which is associated with a class of correspondents or not restricted as to correspondent.

Preferably such acceptable attributes includes one or more of the following: a mail server identity; an encoding of a subject field of the message.

Preferably, said notification of a quasi-legitimate incoming message to the user includes an indication of which sub-class the incoming message belongs to.

Preferably, said classes include a third class of messages (“non-legitimate” messages) in which said comparison result identifies no match between another aspect of the sender identification data of the message and the user data, for example which derive from a sender which has been barred by the user. Preferably, if the message is classified into said third class of messages, said method further includes the step of blocking transmission of the message to the user and preferably notifying the sender of the failed message. The method may further include the step of forwarding to the user (optionally, periodically), a list of such blocked messages. The method may further include the step of forwarding the message to a repository of “non-legitimate” messages which the user may choose to access to review and retrieve.

Preferably, the method of classification includes the steps of a mail server receiving the message, extracting from the message said user address and sender identification data and forwarding the extracted data to a verification server for said classification of the message, and said verification server notifying the mail server of the classification assigned to the message.

Preferably, said user addresses associated with said user include correspondent-specific user addresses each associated with a single correspondent. Said user addresses may also include non-specific (“general purpose”) user addresses associated with a class of correspondents or not restricted as to correspondent.

In another aspect, the present invention provides a method of assignment of a source user address to an outgoing message from a user to a correspondent, including the steps of:

storing user data including a plurality of user addresses associated with said user, each said user address being further associated with one or more correspondents of said user;

reading recipient identification data associated with the outgoing message;

comparing said recipient identification data to said correspondents associated with user addresses of said user; and

upon finding a user address in said user data associated with both said user and the correspondent, inserting said user address as the source address for the outgoing message, or upon failing to find a user address in said user data associated with both said user and the correspondent, generating a new user address associated with both said user and the correspondent, inserting said new user address as the source address for the outgoing message and adding said new user address details to the user data.

Preferably, said user data includes expiry dates for said user addresses, and said method may include the step of extending an expiry date of a user address and/or reviving a user address for which the expiry date has passed

In another form the present invention provides a method of assigning a user address to a message having a real source address and a destination address associated with a correspondent including the steps of: generating said user address based on one or more of the following: a reference to said user identification data; a reference to said correspondent identification data; a reference to identification data of a third party; a reference to an address of said user; a reference to an address of said correspondent; a reference to an address of a third party; a reference to a subject matter of a message; a pre-determined code known to said user; a pre-determined code known to said correspondent; a pre-determined code known to a third party; a random number; instructions on handling that message; and substituting said generated source address for said real source address.

Another form of the present invention resides in a method of classifying an incoming message addressed to a user address of a user including the steps of reading the user address associated with the incoming message, reading sender identification data associated with the incoming message, comparing said sender identification data to said user address to yield a comparison result, and classifying, in response to said comparison result, the incoming message as a member of one of said pre-defined classes of messages.

The invention further provides a computer processor configured to perform the above methods, or a system including a plurality of computer processors such as a mail server, verification server and user address assignment server, which together are configured to perform such methods.

In another aspect, the present invention provides an electronic mail server including:

an interface for receiving an incoming electronic mail message to a user; and

a mail processor configured to extract sender identification data from said message and forward said extracted data to a verification server, to receive from the verification server an authorization code for the message and to tag said message with the authorization tag and transmit the message.

In a yet further aspect, the present invention provides an electronic mail server including:

an interface for receiving an outgoing electronic mail message from a user; and

a mail processor configured to extract recipient identification data from said message and forward said extracted data to a user address assignment server, to receive from the user address assignment server a user address assigned to the message and to insert said assigned user address as a source address for said message and for forwarding the message.

In another aspect, the present invention resides in a computer-readable medium having computer executable instructions stored therein for performing the above-described methods, and to computer-readable medium having stored thereon a user database storing associations between user addresses, users and correspondents for use in the above methods.

In another aspect, the present invention resides in a system for delivery of electronic messages including one or more of the following:

means for classifying an incoming message according to any one of the above described methods of classifying;

means for assigning a user address to an outgoing message, said means being arranged to perform the above-described method of assignment;

means for delaying delivery of an outgoing message;

means for cancelling delivery of an outgoing message;

means for selectively generating an outgoing message upon receiving an incoming message wherein said incoming messages matches one or more criteria specified by the user,

means for detecting an electronic message containing user-specified content,

means for generating an alerting message upon detecting a match between two or more on-line users,

means for analysing an electronic message based on its content, wherein said content includes an employment opportunity,

means for sending a SMS or similar message through a computer terminal,

means for replacing an e-mail attachment to an electronic message with a File Transfer Protocol Utility, said means inserting an URL into the electronic message,

means for penetrating user's security measures to detect and report security risks.

Preferably, said system further includes means for automatically sending a mobile terminal or mobile telephone message to a user upon sending an electronic mail message to said user.

Preferably, said mobile telephone message is an SMS message.

Preferably, said system further includes means for managing a SMS recipient list through a computer terminal.

In another aspect, the present invention provides a method for delivery of electronic message to an intended recipient including the steps of

delaying delivery of the electronic message,

notifying the intended recipient of the message,

prompting the recipient to reply in a specified manner,

upon receiving a reply in the specified manner, sending the message to the recipient, and

advising the sender.

Preferably, said specified manner includes the step of sending a reply message having the same subject field.

In another aspect, the present invention provides a method for preventing delivery of electronic message including the steps of

making known a specified code to be used for preventing delivery of said electronic message,

receiving a first message, said first message being sent by a sender to a user address,

receiving a second message having a subject field, said second message being sent by the same sender to the same user address,

examining the subject field of said second message to ascertain the presence of said specified code,

upon detecting said specified code, comparing said first and said second messages,

upon detecting a match between said messages, preventing delivery of said messages,

advising the sender.

In another aspect, the present invention provides a method for managing a list of intended recipients including the steps of

storing a list of defunct user addresses of a user,

providing means for completing a communication request,

upon receiving said communication request, comparing said communication request to the stored defunct user address data,

upon detecting a match between said communication request and a said stored defunct user address, notifying the user of the communication request.

Reference herein to a “mail server” or other component of an e-mail system will be understood to include reference to a device performing a similar function in other forms of electronic communications, for example a telephone switch in telephone communications.

Also, an “address” may include an e-mail address, a phone number, an internet protocol address, an instant messaging number, etc.

### BRIEF DESCRIPTION OF THE DRAWINGS

Preferred embodiments of the invention will now be described with reference to an example e-mail system called “NoSpamMail” and to the accompanying drawings in which:

FIG. 1 is a schematic high-level block diagram showing a system according to the present invention;

FIG. 2 illustrates a relationship between a real address of a user—a member of “NoSpamMail”—and a surrogate member address issued by NoSpamMail;

FIG. 3 is an extract from a database record of a member of NoSpamMail;

FIG. 4 is an extract from a database record of a surrogate member address recorded in the record in FIG. 3;

FIG. 5 is a high level flow-chart illustrating the process of sending of an outgoing message by a member of NoSpamMail;

FIG. 6 is a flowchart of the process of classifying an incoming message;

FIG. 7 is a floating on-screen indicator panel of a preferred desktop e-mail management program associated with the system;

FIG. 8 illustrates the panel in FIG. 7 in an expanded view.

FIG. 9 is a flow-chart illustrating the process of management of messages held by NoSpamMail subject to member acceptance.

### DETAILED DESCRIPTION OF THE PREFERRED EMBODIMENTS

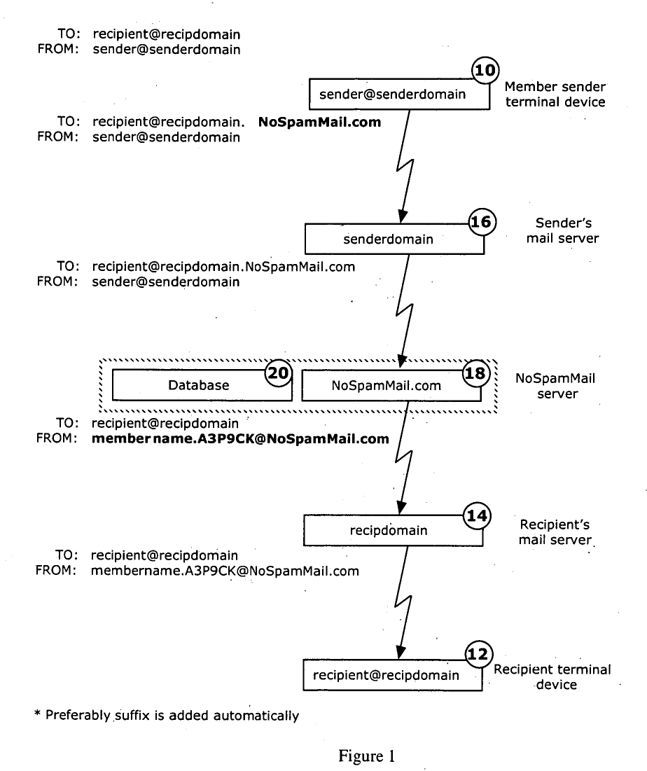

Referring now to FIG. 1, the schematic illustrates an electronic mail system according to a preferred embodiment of the present invention (referred hereafter as “NoSpamMail”) as it applies to the process of sending a message between two individuals each accessing the internet using different internet mail servers.

One of the individuals is a ‘member’ of the NoSpamMail network, ie a person who has joined NoSpamMail and become a ‘user’ of the NoSpamMail service. The word ‘user’ is used interchangeably with the word ‘member’.

An electronic mail message is sent by a member of the NoSpamMail network in the following manner. The user (located at a personal computer or a terminal device 10 connected directly or by wireless) having an e-mail address—sender@senderdomain at an originating domain—senderdomain 16, sends a message via NoSpamMail to a recipient 12 having an e-mail address—recipient@recipdomain at a target domain—recipdomain 14, the recipient's mail server.

The user runs e-mail client software (eg, Outlook Express, Eudora, etc) on the member's terminal device 10 to create an e-mail message. When the message is complete, the user attaches a suffix such as “NoSpamMail.com” to the normal e-mail address of the recipient. The resulting address is recipient@recipdomain.NoSpamMail.com. Preferably, the member's e-mail client software attaches such a suffix automatically.

The e-mail client then interacts with the sending server 16 at senderdomain to handle the sending. The sending server transfers the message to the NoSpamMail.com server.

The NoSpamMail.com server 18 then analyses the “FROM”, ‘TO’, ‘CC’, and BCC fields of the outgoing message to ascertain the name and/or e-mail address of the sender and intended recipients of the outgoing message and accesses a database 20 containing records relating to the member of NoSpamMail sending the message.

A member of NoSpamMail typically has several e-mail addresses. Such addresses may include

1. e-mail addresses provided by ISP,

2. web-based e-mail addresses such as Yahoo and Hotmail,

3. e-mail aliases,

4. e-mail forwarding addresses,

5. addresses appearing on business cards, web sites, in White and Yellow Pages, etc.

To avoid unsolicited e-mail, the user wishes to keep the addresses in categories 1-4 private. Such addresses are referred hereafter as “real addresses”. Addresses in category 5 are intended for public distribution, such addresses being referred hereafter as “general purpose addresses”. The outgoing message received by the NoSpamMail server will typically have a “FROM” address in categories 1,2 or 5.

In the preferred embodiment of the present invention, NoSpamMail creates a new unique address the first time a new recipient of a message is addressed by the member. This unique address is stored in the NoSpamMail database 20 for that member. To achieve this, the receiving server of NoSpamMail 18 analyses the ‘TO’,“CC’, and BCC fields of the outgoing message to determine whether or not the intended recipient matches the existing correspondent identification data stored in the NoSpamMail database for the user.

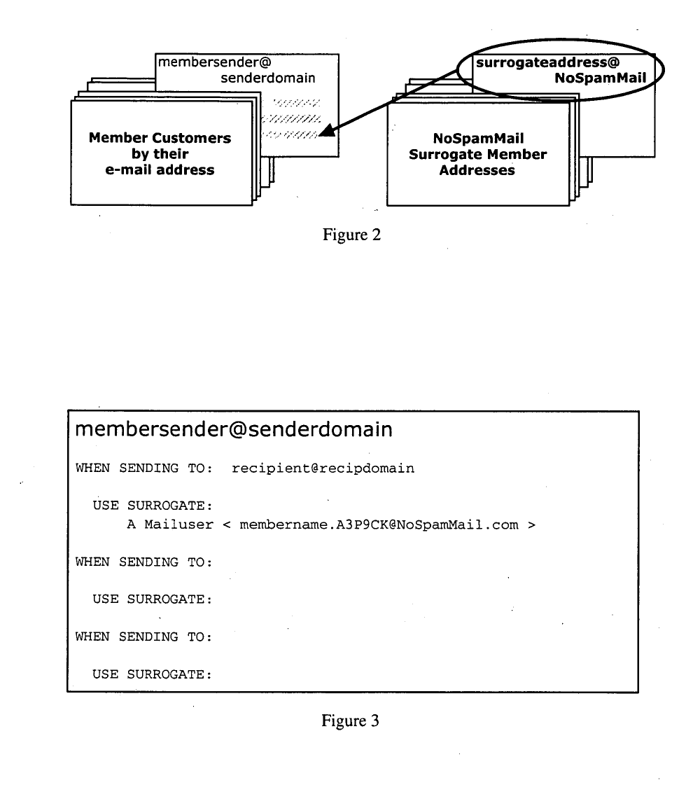

Illustrated in FIG. 2 is a relationship between a ‘real’ address of a member and a surrogate member address issued by NoSpamMail.

FIG. 3 illustrates a database record of a Membersender (a member of NoSpamMail) having a ‘real’ e-mail address—membersender@senderdomain. The record shows that Membersender has a constructed “FROM” address—A Mailuser <mailto:membername.A3P9CK@NoSpamMail.com> issued for correspondence to a recipient having the following address—recipient@recipdomain.

‘Membername’ may be a unique name by which a NoSpamMail member is distinguished within the NoSpamMail system. However in other embodiments of the present invention the construction ‘membername.A3P9CK’ may be a random number, a combination of letters, a combination of letters and numbers, or any other identifier issued to the member/user by NoSpamMail.

The identifier consisting of numbers, letters or some other form may include information identifying aspects of the sender or senders authorised to use Membername of which the identifier is a part. Also, the identifier may include instructions defining the way in which messages should be handled.

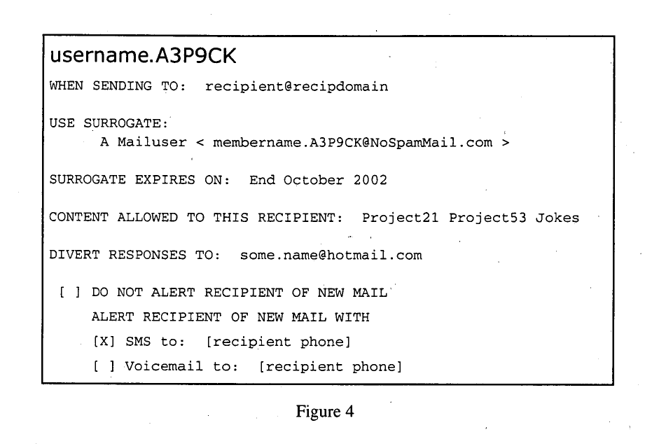

FIG. 4 illustrates a corresponding record for the issued address membername.A3P9CK.

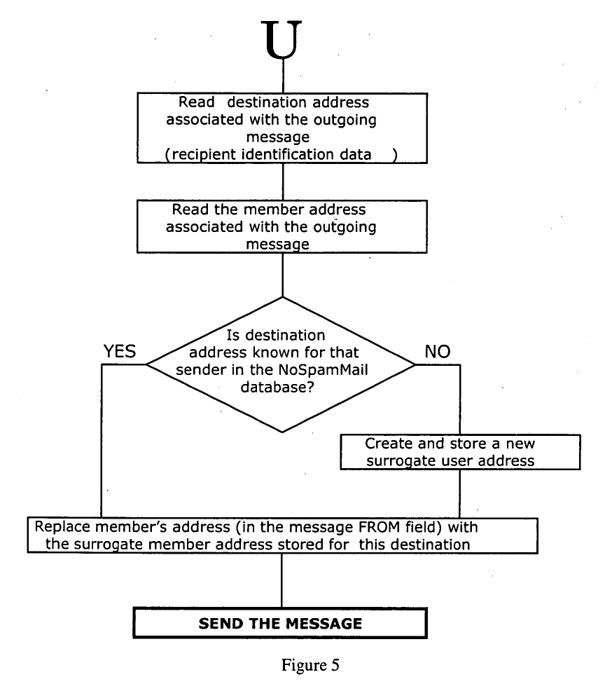

Referring to FIG. 5, if the intended recipient is recognised by the NoSpamMail database, ie. there is a match between the intended recipient of the outgoing message and the stored identification data for that sender, NoSpamMail uses a previously generated e-mail address issued for that recipient.

As a result, the e-mail address of the member is replaced in the FROM field of the outgoing message by the surrogate member address that was issued for correspondence to that recipient and the message is passed on (see FIG. 1).

Upon failing to detect a match between the recipient in the ‘TO” field and the stored data, NoSpamMail generates a unique “FROM” address for that intended recipient. However, in some cases a previously issued user address may be assigned to the recipient.

Preferably, the generated “FROM” address is assigned exclusively for that recipient. NoSpamMail then stores the issued address and other user data in the NoSpamMail database.

In another form of the invention the generated “FROM” address contains encoded information that allows the address, assigned though it is to a specific correspondent, to be used under specified circumstances by one or more other correspondents without reference to the user data in the NoSpamMail database.

Multiple addresses may be issued to the same member of the NoSpamMail network in relation to a single recipient if desired.

Moreover, in some circumstances, a surrogate member address may be issued to a member and/or recipient for correspondence with a group of recipients.

Further, some surrogate member addresses included in the NoSpamMail database may be created by members themselves and/or a trusted third party, for example by the member allocating surrogate addresses associated with each of the correspondents in the member's e-mail program contacts list. The NoSpamMail system then creates surrogate user addresses associated with each of the correspondents and advises each correspondent of the new address for use when communicating with the user.

Preferably, NoSpamMail creates, issues and assigns a unique e-mail address to each of the member's correspondents thereby creating an one-to-one relationship between intended recipients and issued surrogate user addresses.

In the preferred embodiment of the present invention, the step of creating the surrogate e-mail address involves calculating and appending a suffix to the member's membername in the e-mail address. NoSpamMail re-uses the member's “real name”, re-uses the “Membername”, and appends a newly generated suffix to the membername, that suffix being unique to that recipient. The address is formed by concatenating the sending member's membername, the newly generated suffix, the “@” sign, and the domain name of the membersender's NoSpamMail host. The resulting member address is therefore

Real Name<membername.suffix @NoSpamMail.com>

Preferably, the suffix is generated in a fixed alphanumeric structure, for example ANANAA, AANAAN, etc where A is an alpha character and N is a numeric. To avoid potential confusion with other letters and numerals, the letters B, D, I, M, O, S, V, and Z could be excluded. The above described format of the suffix forms no names/words because of the intervening numerals and has 6,553,600 combinations and allows NoSpamMail to correct or accommodate some errors by senders when typing surrogate member addresses as described below.

Preferably also, said suffix contains an encoding of key aspects of the correspondent identification data so a possibly remote message processor can perform an initial verification that the sender is authorised to send to the recipient without reference to a NoSpamMail member database. Preferably also the suffix encodes instructions for the actions to take upon classifying a message as “legitimate”, “quasi-legitimate” and whatever other classifications may apply.

After generating a unique surrogate e-mail address for correspondence with a new recipient, the NoSpamMail database registers the following data:

each pair of e-mail addresses—the surrogate member address (the message FROM field) for the new recipient and recipient's e-mail address (the message TO or CC or BCC fields),

the date of expiry of the surrogate member address,

optionally, whether an alert is to be sent to the message recipient when a message has been sent and, if so, sufficient information to deliver that alert. For example, the mobile phone number of the e-mail recipient to facilitate sending a message such as a short message service (SMS) alert that an e-mail message was sent,

optionally, an indication of the type/s of content class which is appropriate for that recipient. For example, some members may classify content classes as “work”, “family”, “friend”, and “jokes” and another member may classify content by special identifiers to indicate different projects, matters, or orders.

Additional data may include recipient's ID, recipient's address, descriptors of the recipient and nature of interests and relationship, etc.

The NoSpamMail server then replaces the “real” e-mail address of the member in the e-mail with the surrogate member address and the message is passed on to the receiving server 14 in recipdomain (see FIG. 1). The recipient 12 uses his/her e-mail client software to download and read the message in the normal manner.

Preferably the NoSpamMail server further analyses the content class of the message and passes the message to the recipient's domain only if the content class of the message has been deemed appropriate by the member in that recipient's NoSpamMail database record. For example, the subject field of a member's outgoing message may include “Work”. The message will be passed to the intended recipient only if that recipient is authorised to receive “work”-related messages. Similarly, if the subject field contained some code indicating a specific project, for example, “Project 325”, then no-one would be able to receive that message unless their NoSpamMail record explicitly indicated authority to receive messages pertaining to “Project 325”. Failure to include an indication of content in the subject field allows the NoSpamMail server to pass the message to all intended recipients. Preferably the NoSpamMail server alerts the member if a message was not passed on because of violation of the member's content rules regarding an intended recipient.

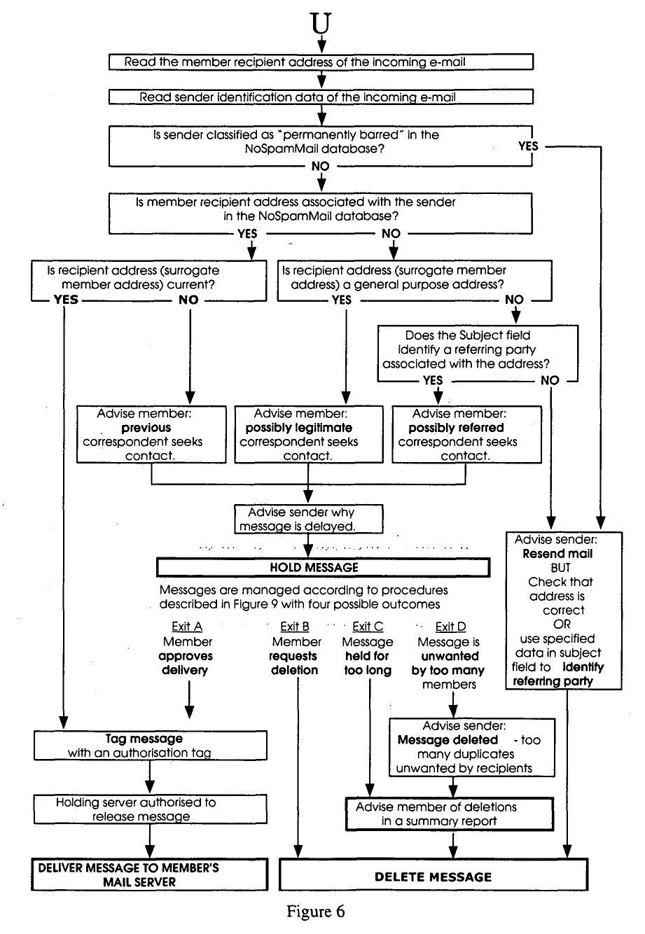

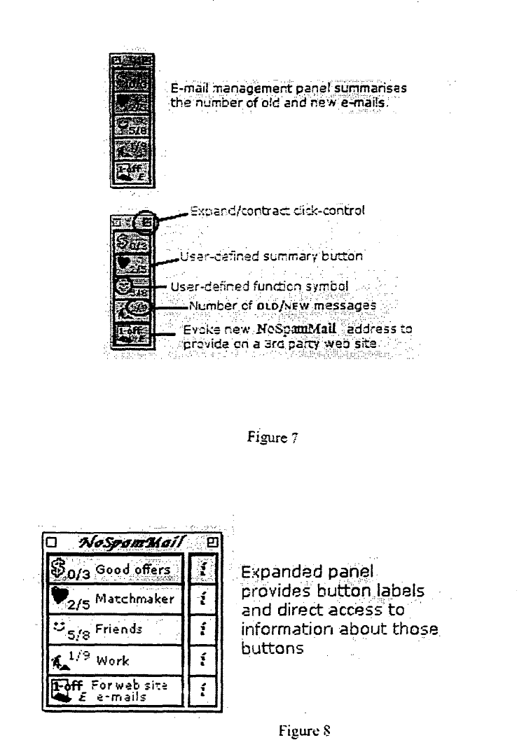

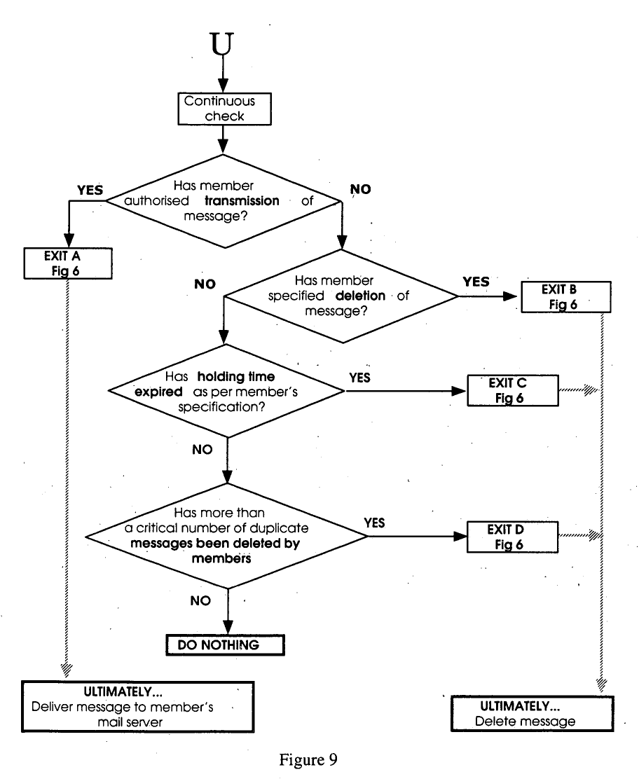

FIG. 6 depicts a high-level flowchart of the process of classifying and verifying an incoming message to the NoSpamMail member. The figure illustrates the basic steps used by NoSpamMail to authorise an e-mail message from a remote host and transfer the message to the member. FIG. 6 also shows an intermediate stage of “holding” messages, ie messages held by NoSpamMail subject to member acceptance. The process of management of such messages is illustrated in greater detail in FIG. 9.

It will be appreciated that a typical transmission path for an e-mail message passes through quite a number of mail servers on the network. The present invention anticipates that some, but not all, of those mail servers will be enabled to perform the method described.

Upon detecting that the incoming e-mail is directed to a NoSpamMail address, the enabled mail server first examines the e-mail message for an existing NoSpamMail authorization tag, which indicates that the message has already been verified and authorised by a NoSpamMail server earlier in the transmission path of the message. If the message carries a valid authorization tag, the server passes on the message without the need for re-verification. The verification tag may include an address specified by the user.

If the message has no verification tag, then the server is the first NoSpamMail-enabled server on the transmission path. The mail server then extracts the sender identification, the relevant destination (TO or CC or BCC) address/es (surrogate member addresses) and the subject field from the message.

The mail server then attempts to validate the message by decoding part of the suffix in the membername.suffix component of the destination and comparing it to the relevant component of the sender address (for example, originating internet domain). Depending on the results the server will decode part of the suffix containing instructions as to how the server should respond to the test results. Depending on results the message could be deleted, stored in one or more of a plurality of servers, provided with an authorization tag allowing the message to proceed unhindered through the network for further checks, or even delivered directly to the intended recipient identified in the destination field.

Preferably, if the server test concludes that a message should not be simply deleted, the server spools the message and forwards the extracted information to a NoSpamMail verification server for verification. The verification server may be remote from the mail server, for example one of a plurality of mirrored servers on the network, or may be a software function of the same mail server computer.

In this example it is assumed that the surrogate member address is unique to each intended correspondent of the member and each surrogate address is assigned exclusively to one correspondent. In other words, there is a one-to-one relationship between the surrogate member addresses and the member's correspondents.

The verification server examines the sender identification data and the surrogate user address to which the message has been sent. If the sender has been permanently barred from sending messages to that member the message is deleted and the sender is advised as described below.

If the user address is associated with that sender and the address is still current, then NoSpamMail classifies the message as legitimate and issues a verification tag for the message. The tag is sent back to the mail server, which tags the code to the message and forwards on the message. The tag acts to authorise transmission of the message through any further NoSpamMail-enabled servers in the network transmission path to the user.

If the user address matches with the sender but has expired, the incoming e-mail is categorised as quasi-legitimate and is spooled by the mail server. The message will be held for a period. Preferably the member defines “holding expiry rules” based on one or more of the following: date and time that the message was sent, date and time since the member last reviewed NoSpamMail “holding advices”, date and time of member's last log on to NoSpamMail service. The member will be notified that a message has been received from a previously authorised correspondent (name/address and subject provided). The member can choose to either take delivery of this one message, choose to delete the message, or allow it to be deleted automatically after “holding expiry” and/or either to extend the expiry date of that user address or cancel the address (the previously authorised correspondent becomes “unknown”). If the member accepts the message, the message is issued an authorization tag, extracted from the spooler, and transmitted on.

The sender of the quasi-legitimate message is advised that message delivery is delayed because their authority to use that user address has expired. If the NoSpamMail member chooses to reject delivery then the sender will receive a request to delete that surrogate member address from sender's records.

If the sender is not associated with the surrogate member address to which the message is sent, the NoSpamMail verification server compares the relevant address of the incoming message to a list of general purpose, non-specific, user addresses. If the surrogate member address matches a general purpose address (for example, an address from the member's business card) then the incoming message is categorised as quasi-legitimate. The message will be held according with the instructions specified by the member and the member will be notified that a message has been received from a person using a general purpose address. The notice will include the sender's details and the subject of the message. The member can choose to either take delivery of this one message, choose to delete the message, or allow it to be deleted automatically after “holding expiry” and/or authorise that sender and/or cancel the general purpose address, as discussed above. The member may also be given an option to generate a new surrogate address for that correspondent.

The sender of the quasi-legitimate message is advised that message delivery is delayed because the member must choose to take delivery of the message. If the NoSpamMail member chooses to reject delivery then the sender will receive a request to delete that general purpose address from the sender's records.

If the surrogate member address is not a non-specific address, the NoSpamMail server proceeds to examine the information in the subject field of the incoming message.

If the subject field contains an identification of a recognised current or previous correspondent for that surrogate member address, then the incoming message will also be classified as quasi-legitimate. Examples of the identification of a recognised current or previous correspondent include the e-mail address or phone number of that recognised correspondent or some code agreed between member and correspondent. The message will be held as described above and the member is notified that a message has been received from a person who appears to have been given the user address previously issued to the recognised correspondent. The notice will also include details of sender, subject, and the recognised correspondent. The member can choose to either take delivery of this one message, choose to delete the message, or allow it to be deleted automatically after “holding expiry”. The member may also authorise that sender and/or cancel the surrogate user address previously issued to the recognised recipient who appears to have passed it to other/s.

The sender of the message is advised in the manner described above.

Notification to the member of the receipt of quasi-legitimate messages is preferably by way of a periodically reported list, with the frequency and content of notification determined by the member's preferences. For example, a user may specify that he/she wishes to receive a daily report concerning messages sent using a general purpose address from a business card and a weekly report of all other quasi-legitimate messages received. The member may receive an updated list at any time by on-line request to NoSpamMail. Preferably such an on-line request would occur via the NoSpamMail desktop utility.

If the subject field does not satisfy any of the criteria for a legitimate or quasi-legitimate message, the incoming message is classified as a non-legitimate message. Such messages are automatically deleted. The member may choose to receive a list of such deletions periodically or on request, again as specified in the member's preferences.

The sender of a non-legitimate message of this type is advised that an error has occurred: either they are not authorised to send e-mail to the NoSpamMail member in which case the sender should delete the surrogate member address from his/her address book, or that sender has been permanently barred from sending e-mail to the member, or, if the address has been passed to them by a recognised correspondent of the member, the sender should resend the message including in the subject field a specified identification of the known correspondent as described above. Otherwise they are unable to send and should delete this user address.

Preferably, where a message is held subject to member acceptance, if the same message has been sent to some large number of NoSpamMail members and some critical number of those members have deleted the message then all undelivered copies of that message will be deleted across all NoSpamMail member accounts. The sender will be notified that too many copies of an unwanted message were sent and these have been deleted. The deletion may or may not be reported to the member in accordance with the member's preferences.

In another form of the invention a NoSpamMail member may encode in the address suffix instructions to delay processing of an incoming message by the first mail server to receive the message. During this delay period the NoSpamMail system will accumulate statistical data on the pattern of incoming messages so delayed. If some critical number of specific messages or. messages from a specific sender or messages from a particular source (for example a mail server) is exceeded then some or all of the affected messages may be deleted, classified as non-legitimate, or stored for some period for analysis and processing at some other time.

### EXAMPLE

The invention is now further described by way of an example, in which NoSpamMail has received nine messages addressed to a member of NoSpamMail. None of the messages has previously been checked by a NoSpamMail-enabled server on the transmission path.

The member maintains three e-mail addresses:

| | |
|---|---|
| 1 | work_address@employer.com |
| 2 | home_address@household.com |
| 3 | other_stuff@hotmail.com |

The following sender's e-mail addresses are extracted:

| | |
|---|---|
| Message 1 | daughter@family.com |
| Message 2 | ex-wife@divorced.com |
| Message 3 | wife@family.com |
| Message 4 | unrecognised@unknown.com |
| Message 5 | spammer@commercial.com |
| Message 6 | businesscontact@corp.com |
| Message 7 | neighbour@local.net |
| Message 8 | friend_of_friend@refer.com |
| Message 9 | pest_salesman@hotdeals.com |
| Message 10 | LawyerTwo@greatlawfirm.com |
| Message 11 | pest_salesman@hotdeals.com |

The senders are classified as known senders and unknown senders:

Known Senders

For the known senders, the surrogate member address of the e-mail is compared to the surrogate address associated with the sender, and the status of the associated surrogate address of the sender is determined.

Message 1

| | |
|---|---|
| Sender: | Daughter |
| Sender address: | daughter@family.com |
| Assigned surrogate address: | membername.A3P9CK@ |
| | memberdomain |
| Address used by sender: | assigned surrogate member address |
| Source: | Assigned by NoSpamMail |
| Status: | Issued to Daughter. Current |
| Incoming messages diverted to: | home_address@household.com |

In this example the assigned surrogate member address used by the sender is current, and matches the user address associated with that sender. That message is issued with an authorization tag and transmitted on to the member. The authorization tag may include a specific real address of the member associated with this particular sender, for example the tag may include the member's diversion address of home_address@household.com.

Message 2

| | |
|---|---|
| Sender: | Ex-wife |
| Sender address: | ex-wife@divorced.com |
| Assigned surrogate address: | membername.A7R2JC@memberdomain |
| Address used by sender: | assigned surrogate member address |
| Source: | Previously assigned by NoSpamMail |
| Status: | Issued to Ex-wife. Expired |
| Incoming messages diverted to: | not applicable |

In this example the assigned surrogate member address used by the sender has expired. In such a case, the member may be advised that an old correspondent seeks contact using an expired address. If the member chooses to accept the message, it will be issued with an authorization tag and forwarded to the appropriate real e-mail address as specified in the member's preferences recorded in the NoSpamMail database. The member may also be given the option of permanently barring that correspondent, or of extending the expiry date for that correspondent's surrogate address.

Message 3

| | |
|---|---|
| Sender: | Wife |
| Sender address: | wife@family.com |
| Assigned surrogate address: | membername.K5G3LE @ |
| | memberdomain |
| Address used by sender: | membername.K5GBLE @ |
| | memberdomain |
| Source: | Assigned by NoSpamMail |
| | (Sender has made a typing error) |
| Status: | Issued to Wife. Current |
| Incoming messages diverted to: | home_address@household.com |

In this example the assigned surrogate member address is a valid address. However, for unknown reasons the sender (Wife) does not use the user address assigned to her. For example, perhaps a typing error has resulted in her sending to membername.K5GBLE instead of to membemame.K5G3LE. The member may be notified that a legitimate correspondent seeks contact using a different address. Alternatively, the member may specify in the member preferences to automatically accept such messages and deliver them to a specified address.

In one implementation of the present invention, error detection and correction could be applied to the incorrect address. In this example the suffix coding system should have a numeral in the fourth position. If the numerals “3” and “8” are misread as a letter, then that misreading is likely to be the letter “B”. As such, NoSpamMail may attempt correction of the suffix by replacing the letter “B” appearing in the numeral position with first “3” and then 8”, checking each to attempt a match with a user address associated with that sender. If a successful match is found then the notification sent to the member may include the NoSpamMail system's “guess” at the current authorization of the sender.

Unknown Senders

For the unknown senders, the NoSpamMail server assesses the type of surrogate member address used by the sender and may also consider the response to an incoming message from other NoSpamMail members.

Message 4

| | |
|---|---|
| Sender: | Unrecognised |
| Sender address: | unrecognised@unknown.com |
| Assigned surrogate address: | none (no previous correspondence) |
| Address used by sender: | one-off_suffix@memberdomain |
| Source: | Member-supplied in web form |
| Status: | General purpose, “one-off”. Current |
| Incoming messages diverted to: | other_stuff@hotmail.com |
| | (after first message received) |

In this example the surrogate member address is a general purpose address that was generated by NoSpamMail as a result of a member request for a “one off” general purpose address. In this instance the member subscribed to an online movie newsletter. The newsletter subscription form on their web site required an e-mail address. The member entered the “one off” general purpose e-mail address generated by NoSpamMail in response to a request by the member. In such a circumstance, the first incoming message to use that general purpose address is classified as quasi-legitimate, reported to the member, and held by the server for a specified period. In this example the member authorises this and future e-mails (the newsletters to which the member has subscribed) and specifies that those e-mails newsletters be diverted to a personal destination address.

Message 5

| | |
|---|---|
| Sender: | Unrecognised |
| Sender address:. | spammer@commercial.com |
| Assigned surrogate address: | none (no previous correspondence) |
| Address used by sender: | membername.web_suffix@ |
| | memberdomain |
| Source: | taken from web site or directory |
| Status: | General purpose. Current |
| Incoming messages diverted to: | not applicable |

In this example the surrogate member address used by the message sender was taken from some internet source—perhaps captured from a corporate web site or online directory. It may have been published to provide the means for legitimate business correspondents to contact the NoSpamMail member. In this example it has been abused by a “spammer”.

In such circumstance incoming messages may be subjected to multiple filtering/classification processes. In the first stage, the message is classified as quasi-legitimate, reported to the member, and held by the server for a specified period. The sender may be advised that an error condition has prevented delivery: the address is invalid or the sender must identify the source of referral. In addition, in the second stage, the management of the message is performed by reference to one or more of the following:

the experience of NoSpamMail members with the sender of that message,

whether other members have received the same message from the same source,

the number of members who decided to delete the message,

the nature of messages arriving at “spam detecting” addresses,

whether a large number of messages with functionally identical content are being sent to NoSpamMail members through one or a few NoSpamMail servers, etc.

For example, other NoSpamMail members may have received the same message from the same source that is also unknown to them. If some critical number of those other members delete that message (actively or by time default), then NoSpamMail may automatically delete all unopened copies of that message in the NoSpamMail system. NoSpamMail may notify the sender that the message was deleted because a critical number of NoSpamMail members classified the message as unwanted. These processes may apply to Message 5 of “spammer” which would be removed automatically by NoSpamMail.

In another implementation of the present invention NoSpamMail may establish and publish addresses that are not used by a member for routine correspondence. Rather, they exist for no other purpose than to attract spam. If more than some critical number of these addresses receive a functionally identical message from the same source then such messages may be deleted from the entire NoSpamMail system and the sender notified as above.

In another implementation of the present invention NoSpamMail may analyse the pattern of traffic between NoSpamMail servers. A large number of messages entering the NoSpamMail system through one or few NoSpamMail servers all with functionally identical content can be delayed, analysed, and possibly deleted automatically with the sender advised as above.

Message 6

| | |
|---|---|
| Sender: | Unrecognised |
| Sender address: | business_contact@corp.com |
| Assigned surrogate address: | none (no previous correspondence) |
| Address used by sender: | membername.generic_suffix@ |
| | memberdomain |
| Source: | Member, from current business card |
| Status: | General purpose. Current |
| Incoming messages diverted to: | work_address@employer.com |
| | (after first message received) |

In this example the surrogate member address may be a general purpose address that appears only in print (such as business card or letterhead). This surrogate member address is classified as quasi-legitimate, reported to the member, and held by the server for a specified period. In this instance, if approved by the member, this message would be routed to work_address@employer.com.

This Message 6 could be subjected to the extra tests that apply to Message 5. However, the absence of some critical number of functionally identical messages from functionally identical sources means that Message 6 is not automatically deleted by NoSpamMail.

Message 7

| | |
|---|---|
| Sender: | Unrecognised |
| Sender address: | neighbour@local.net |
| Assigned surrogate address: | none (no previous correspondence) |
| Address used by sender: | membername.phonebook@ |
| | memberdomain |
| Source: | Printed or electronic directory |
| Status: | General purpose. Current |
| Incoming messages diverted to: | work_address@employer.com |
| | (after first message received) |

In this example the surrogate member address may be a general purpose address that appears only in print (such as business card or letterhead). This surrogate member address is classified as quasi-legitimate, reported to the member, and held by the server for a specified period. In this instance, if approved by the member, this message would be routed to work_address@employer.com. If the member responds to Message 7, NoSpamMail will automatically issue the Neighbour with a surrogate member address.

This Message 7 could be subjected to the extra tests that apply to Message 5. However, the absence of some critical number of functionally identical messages from functionally identical sources means that Message 7 is not automatically deleted by NoSpamMail.

Message 8

| | |
|---|---|
| Sender: | Unrecognised |
| Sender address: | friend_of_friend@refer.com |
| Assigned surrogate address: | none (no previous correspondence) |
| Address used by sender: | membername.A3P9CK@ |
| | memberdomain |
| Source: | Assigned by NoSpamMail |
| Status: | Issued to Daughter. Current |
| Incoming messages diverted to: | not applicable |

In this example the sender is using a surrogate member address that has been issued to someone else. The NoSpamMail server analyses the subject field and the surrogate member address to which the e-mail was sent seeking an indication that the sender was referred by a mutual correspondent. In this example the subject field of Message 8 from “friend of a friend” contains part of the daughter's work phone number. As this is information that forms part of the Daughter's data in the member's NoSpamMail records and the surrogate member address issued to Daughter is both known and current, the message is classified as quasi-legitimate, reported to the member, and held by the server for a specified period. In this instance the member accepts the message directing it to home_address@household.com. Future e-mails from this source are not authorised per se—to do so would be to have multiple users of the surrogate member address issued to Daughter. Instead, the member replies to the daughter's friend at friend_of_friend@refer.com. Having not encountered this correspondent before NoSpamMail automatically generates a surrogate member address for this correspondent and gives the member an opportunity to direct future messages from this correspondent to specific e-mail addresses.

Message 9

| Sender: | Insurance salesman |
|---|---|
| Sender address: | pest_salesman@hotdeals.com |
| Assigned surrogate address: | Assigned by NoSpamMail |
| Address used by sender: | membername.C8T5WJ@memberdomain |
| Source: | Assigned by NoSpamMail |
| Status: | Issued to insurance agent. Barred |
| Incoming messages diverted | not applicable |
| to: | |

In this example the sender is using a surrogate member address that had been issued to him. However the member has long since ceased wanting correspondence with this person and has denied permission for that sender to send messages. In this instance NoSpamMail recognises that the surrogate member address was issued to that sender but also recognises that this sender is barred. The message is deleted and the sender may be advised that an error condition has prevented delivery: the address is invalid or the sender must identify the source of referral.

Message 10

| | |
|---|---|
| Sender: | Colleague of member's lawyer |
| Sender address: | LawyerTwo@greatlawfirm.com |
| Assigned surrogate address: | Assigned by NoSpamMail to LawyerOne |
| Address used by sender: | membername.G1X9AP@memberdomain |
| Source: | Assigned by NoSpamMail |
| Status: | Issued to LawerOne. Current. |
| Incoming messages diverted | work_address@employer.com |
| to: | |

In this example the sender is using a surrogate member address that had been issued to a colleague in the same law firm. The member's primary relationship is with LawyerOne but LawyerTwo is also working on some matter of importance to the member and uses the member's e-mail address issued to LawyerOne to send a message to the member.

The first method compliant server receiving the message is able to identify from the suffix G1X9AP that the correspondent is commercial, and that the message is expected to come from a source with which “greatlawfirm” in the sender domain complies. Even though the address was issued to LawyerOne, the fact that LawyerTwo is from the same firm and that the communication is commercial and that the domain “greatlawfirm” is NOT associated with some critical number of messages arriving at NoSpamMail method-compliant servers, means that the incoming message is handled according to a rule also embedded in the suffix—in this case provide an authorization tag to allow the message to proceed through the network.

If the member responds to the message then NoSpamMail may or may not generate a unique surrogate address for LawyerTwo depending on the member's preferences.

Message 11

| | |
|---|---|
| Sender: | The insurance salesman |
| Sender address: | pest_salesman@hotdeals.com |
| Assigned surrogate address: | Assigned by NoSpamMail to LawyerOne |
| | of the Great Law Firm |
| Address used by sender: | membername.G1X9AP@memberdomain |
| Source: | Assigned by NoSpamMail |
| Status: | Issued to LawerOne. Current. |
| Incoming messages diverted | work_address@employer.com |
| to: | |

In this example the sender is using a surrogate member address that had been issued to a lawyer who once acted on behalf of the insurance salesman who has somehow received the member's e-mail address.

The first method compliant server receiving the message is able to identify from the suffix G1X9AP that the correspondent is commercial, and that the message is expected to come from a source with which “greatlawfirm” in the sender domain complies. The server analyses the structure of the sender's address and discovers a mismatch between the expected domain and the actual domain. The server then determines from a rule embedded in the suffix that such a mismatch is deemed unacceptable.

The server then extracts the relevant rule from the suffix and classifies the message as “quasi-legitimate” or “non-legitimate” as appropriate and treats it as in earlier examples. Preferably the suffix will encode rules allowing the distinction between commercial and personal correspondents and different types of activities with which correspondence is expected thereby allowing varying application of classification rules in different circumstances.

The above-described process of classifying an incoming message ensures that e-mail does not leave an NoSpamMail-compliant server until the message is classified as a legitimate message or, if the message is classified as a quasi-legitimate message, until NoSpamMail has received an instruction from the member authorising transfer the message. Therefore, as soon as the sender's e-mail encounters an NoSpamMail-compliant server, the message does not proceed through the network and intermediate servers until NoSpamMail has verified that the e-mail will be accepted by the NoSpamMail member.

It is possible to perform the invention on any computer with access to the network over which the message is sent, for example at a proxy server, a relay server, a mail forwarding server or a desktop server. Preferably, said system is implemented at a remailer or firewall host.

Other embodiments of the present invention may involve different network topologies involving combinations of multiple NoSpamMail servers, mail server functions performed on a senders' and/or recipients' computers, wireless links, and various terminal devices.

It is desirable to perform the above-described process of classifying an incoming message as close to the sender of the message as possible thereby reducing network traffic and conserving network bandwidth. Therefore it is preferred that at least the mail server performing the spooling, extracting and tagging functions for processing incoming mail be carried out at internet service provider (ISP) level, preferably at the ISP of the sending party. The verification server to which the extracted information is sent for authorization of the message may also be operated by the ISP, but preferably is centralised at one of a number of mirrored servers operated by a guardian for the system.

However, alternative embodiments may be implemented using the traditional e-mail sending server—receiving server configuration. Furthermore, some steps of the present invention may be performed locally, while other steps may be delegated to a third party network/server.

For example, the method of assignment of a surrogate user address may be performed locally on the member's computer or the server for the member's local network. The database containing the issued surrogate addresses and associated user information may be stored on the sending server, but preferably is also communicated to the centralised verification server.

FIG. 7 illustrates a desktop utility, operable on the member's computer upon a connection to a network, to analyse and report the member's e-mail traffic over the network.

The utility includes means for visually reporting a summary of incoming e-mail using a floating on-screen indicator panel. The utility allows a member of NoSpamMail to define the categories into which incoming e-mail is to be classified and allocates icons to identify those categories. The utility also allows the member to manage the member's incoming and outgoing e-mails via the NoSpamMail system, set member preferences and settings such as permanently barring certain correspondents or resetting the expiry date for a correspondent or changing the classes of content that a message recipient can receive from the member, or accessing other resources at NoSpamMail web sites.

FIG. 8 provides an example of e-mail management panel having four categories: “good offers”, “matchmaker”, “friends”, and “work”. The utility has an option of automatic category allocation based on preferences specified by the member. For example, automatic category allocation can include

deletion with or without auto responses;

classification into one or more categories (such as “friend”, “work”, “special offer”, etc);

classification by any combination of sender, date, subject, or body keywords;

classification based on issued surrogate member addresses;

classification based on real addresses;

classification based on general purpose addresses;

classification based on the above-described classification of incoming mail by the NoSpamMail system.

The utility may report the member's incoming e-mail traffic in the categories specified by the member.

The utility may include a link taking the member to a web site that displays the selected category of messages allowing selective download, deletion, or web-based e-mail response, and management of attachments. The utility also allows a member to easily manage e-mail with large attachments—either changing their position in the arrival queue or employing an FTP (File Transfer Protocol) utility. The FTP utility replaces all attachments, or those above a specified size, with a URL inserted into the body of the e-mail for download via FTP protocol at the recipient's discretion, thereby minimising problems that mail servers experience with large attachments.

Summaries of the body of incoming e-mails may also be generated to provide a more useful insight as to content than sometimes misleading Subject fields.

As it can be seen from FIG. 8, the panel may expand to provide button labels and displays an extra set of buttons that provide access to the member's filtering rules for each of the e-mail categories.

The utility may include an “away” setting. For specified categories of incoming mail, a member can specify outgoing messages to be generated automatically. For example:

. . . I am on leave until [date]

. . . I am away from my desk until [time]

. . . Restaurant for the Birthday party is now [details].

The utility also places on the Clipboard a new surrogate member address for the member, which the member may “tear off” and paste into the appropriate field of a website form, or paste into e-mail or other communication as a return address for the member.

When the member takes the “tear off” surrogate address, NoSpamMail automatically generates a new member address in anticipation of the next request.

A member can optionally store images with NoSpamMail to which a “tear off” surrogate address can be added automatically to produce business cards, brochures, letter head, etc. An example of such use is a trade show. The member could generate an e-mail address specific to that event and produce business cards bearing that e-mail address. The member could then readily identify incoming e-mails resulting from direct or indirect trade show contacts.

A member can optionally choose to delay delivery of an outgoing e-mail by several hours unless marked “urgent”. This provides the member sender with some safety from accidentally activating “Send Mail” prematurely. Delayed transmission by NoSpamMail also allows sent mail to be cancelled before delivery. Specifying “Urgent” on an outgoing e-mail over-rides the delayed transmission feature.

Preferably the system may be used to facilitate the classification of reply messages based on the content and/or its “SUBJECT” field of the originating message sent by the member. This can also happen if an address issued to a recipient has passed its expiry date and the member resumes correspondence with that recipient (see FIG. 4). Alternatively, members may be given means to change the status and/or parameters of a surrogate member address, in particular to revive an expired address, to extend/contract the expiry date.

Preferably, the system for delivery of electronic mail further includes means for automatically sending a message (such as SMS) to the mobile device of the recipient of an incoming or outgoing e-mail upon sending an electronic mail message. For example, a member may send an e-mail and automatic SMS message alerting the recipient that e-mail has been sent. Members may send messages to mobile devices such as mobile phones and hand-held computers via their computer keyboard rather than the input medium of the mobile device (such as mobile phone keypad or hand-held computer screen). Members can also manage the recipient lists of SMS and similar messaging services on-line rather than via a phone interface.

In one preferred embodiment, e-mails may be sent “Registered Delivery” by a member whereby delivery of the e-mail is delayed, and the intended recipient receives a notice generated by NoSpamMail that an e-mail from an undisclosed sender is waiting for collection. To have the e-mail sent the intended recipient indicates acceptance to the NoSpamMail system by means such as replying without altering the subject field, or activating a link embedded in the body of the Registered Delivery notice, or some other process. Upon receipt of the Reply, NoSpamMail both transmits the e-mail to the recipient as intended by the sender and advises the member sender that message delivery was requested by the recipient and transmitted. Unlike the delivery receipt facilities of existing e-mail client programs, this process does not rely on the use of embedded code in the e-mail to succeed or the co-operation of the recipient in acknowledging receipt after delivery of the message.

The system may further provide a “Find Me” feature, whereby members can list their old e-mail addresses, phone numbers, postal addresses or other forms of “address”, with NoSpamMail. Anyone seeking to use an otherwise expired address (such as e-mail or phone number) can visit the NoSpamMail site and complete an on-line form to request contact. The member is then alerted to the requested contact and can either accept the request, ignore the request or block further contact from that source. This allows a member, upon joining the NoSpamMail service, to cancel the member's existing addresses and direct all new mail through the NoSpamMail system. The “Find Me” feature may further include an error detection algorithm to identify “near misses” so that a member can still be found in a list of similar addresses should the person seeking contact misspell a name or address.

As a value-added service, the member's settings may specify that all incoming messages be virus-checked before delivery, and to periodically update the member's anti-virus protection. The member may also specify that the system from time to time attempts to penetrate member's security measures and report to the member on detected security risks with possible solutions.

Members of the system may establish relationship with any third party product or service provider for specific purchases in the knowledge that when their need expires there will not be any more e-mail from the third party. Further, the system may be set to filter the member's mail to identify any short-term offers or other messages with an imminent return date. Time limited offers are thus not lost as a result of being embedded in a large number of other, irrelevant offers in the same e-mail in tray.

“Romance alerts” may be generated when two complementary people are on-line at the same time. Each can receive an alert about the other.

Messages regarding possible employment opportunities may be filtered on subject matter or sender, or the system may search for published employment opportunities which match search criteria set by the member, download the details and notify the member.

Further, a person sending a message to a NoSpamMail member may prevent the delivery of that message to the recipient by re-sending the message with a pre-defined code included in the Subject Field. For example, such a code may include the word UNSEND inserted at the beginning of the subject field.

If the member's domain server is NoSpamMail complaint and if the message has not been delivered to the member's e-mail client, then NoSpamMail will delete the message and advise the sender of successful deletion. The intended recipient of the message may be advised that a message from that sender was deleted before delivery.

If the message has been delivered before the request to UNSEND was received then the sender will be advised of the failure to delete the message. Preferably, a NoSpamMail server holding messages for delivery will also respond to a request from a sender to UNSEND a message and issue notification to the sender and member-recipient as above.

Members responding to, or participating in, public activities such as responding to advertisements or requesting some types of information may, in some circumstances, retrieve statistics describing the number of other NoSpamMail members who have also responded to that advertisement or have sought the same types of information.

Members can also receive desktop alerts of traffic and transport problems on specific routes.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein. For example, while the preferred forms of the invention are described in detail with reference to e-mail communications, the principles and scope of the invention also have application to other forms of electronic communication, such as fixed or mobile telephone systems, instant messaging systems such as MS Messenger or ICQ, pager systems and mobile terminal and mobile telephone messaging, for example short message system (SMS) communications.

It will further be understood that any reference herein to known prior art does not, unless the contrary indication appears, constitute an admission that such prior art is commonly known by those skilled in the art to which the invention relates.

I claim:

1. In a communications network, a method of processing a message addressed to a user address, including the steps of:
receiving the message at a message processor; said message processor checking for a valid authorization tag issued to the message;
if the message has a valid authorization tag, said message processor transmitting the message through the network to the user;
if the message does not have a valid authorization tag, delaying transmission of the message until verification of the message is conducted; and
if the message is verified, issuing an authorization tag to the message and said message processor transmitting the message through the network to the user; or if the message is not verified, not issuing an authorization tag to the message and said message processor not transmitting the message through the network to the user.

2. A method according to claim 1 wherein said verification includes the step of verifying sender identification data against user address data of the message.

3. A method according to claim 2 wherein said message processor extracts said sender identification and user address data from the message and forwards said data to a verification processor to perform said verification.

4. A method according to claim 3 wherein if the message is verified, the verification processor issues an authorization tag for the message, said authorization tag being tagged to the message by the message processor.

5. A method according to claim 3 wherein said message is an electronic mail message, and said message processor is a mail server, and said -verification processor is a verification server.

6. A method according to claim 5 wherein said network includes a plurality of said mail servers enabled to perform a method according to claim 1, and a message transmission path of the message from the sender to the user address passes through two or more of said method-enabled mail servers.

7. A method according to claim 6 wherein once a message is verified and issued with an authorization tag by performance of said method upon encountering a first said method-enabled server in the message transmission path, subsequent performances of the message by subsequent method-enabled mail servers in the message transmission path detect the authorization tag and on-transmit the message without re-verification of the message.

8. A method according to claim 1 wherein said authorization tag is a code which is tagged to the message.

9. A method according to claim 8 wherein said authorization tag includes information identifying a user-specified address to which said message is to be forwarded.

10. A method of classifying an incoming message addressed to a user address of a user into one of a plurality of pre-defined classes including the steps of
storing user data including a plurality of said user addresses associated with said user, each said user address being further associated with one or more correspondents of said user,
reading sender identification data associated with the incoming message, comparing said sender identification data to said user data to yield a comparison result, and
classifying, in response to said comparison result, the incoming message as a member of one of said pre-defined classes of messages.

11. A method according to claim 10 further including the step of reading the user address associated with the incoming message.

12. A method according to claim 11 further including the step of comparing the sender identification data with said correspondents associated with said user address to which the message is addressed.

13. A method according to claim 12 wherein said classes include a first class of messages in which said comparison result identifies a match between a sender of the message and a correspondent associated with a live user address to which the message is addressed.

14. A method according to claim 13 further including the step of transmitting the message through the computer network to said user associated with said user address if the message is classified into said first class of messages.

15. A method according to claim 13 further including the step of distinguishing said legitimate messages in a pre-defined manner by tagging the message with an authorization tag.

16. A method according to claim 12 wherein said classes include a second class of messages in which said comparison result identifies a match between an aspect of the message and the user data.

17. A method according to claim 16 wherein said aspect of the message is an aspect of the sender identification data of the message.

18. A method according to claim 16 wherein said aspect of the message is an aspect of the user address of the message.

19. A method according to claim 16 further including the steps of storing the message, notifying the user and seeking authorization for transmission of the message from the user if the message is classified into said second class of messages.

20. A method according to claim 19 further including the steps of distinguishing the message by tagging with an authorization tag and transmitting the message through the computer network to the user if the user grants said authorization.

21. A method according to claim 19 further including the step of deleting said message after a pre-determined time has elapsed if the user does not grant said authorization.

22. A method according to claim 21 further including the step of forwarding to the user a list of such deleted messages.

23. A method according to claim 22 wherein said step of forwarding is performed periodically.

24. A method according to claim 16 wherein said second class of messages includes a plurality of sub-classes, including one or more of the following sub-classes:
messages where the identity of the sender matches a correspondent associated with an expired user address to which the message is sent;
messages from a correspondent associated with a user address of said user, sent to a different user address of the user;
messages from a correspondent not associated with a user address of said user, sent to an address provided for the use of another correspondent, said correspondents sharing message attributes that are acceptable to said user;
messages where the subject field of the message includes a correspondent associated with the user address; and
messages sent to a non-specific(‘general purpose’) user address which is associated with a class of correspondents or not restricted as to correspondent.

25. A method according to claim 24 wherein said notification of a quasi-legitimate incoming message to the user includes an indication of which sub-class the incoming message belongs to.

26. A method according to claim 12 wherein said classes include a third class of messages in which said comparison result identifies no match between an aspect of the message and the user data.

27. A method according to claim 26 further including the step of blocking transmission of the message to the user if the message is classified into said third class of messages.

28. A method according to claim 26 further including the step of notifying the sender of said message.

29. A method according to claim 27 further including the step of forwarding to the user a list of such blocked messages.

30. A method according to claim 29 wherein said step of forwarding is performed periodically.

31. A method according to step 10 further including the steps of a mail server receiving the message, extracting from the message said user address and sender identification data and forwarding the extracted data to a verification server for said classification of the message, and said verification server notifying the mail server of the classification assigned to the message.

32. A method according to step 12 further including the steps of a mail server receiving the message, extracting from the message said user address and sender identification data and forwarding the extracted data to a verification server for said classification of the message, and said verification server notifying the mail server of the classification assigned to the message.

33. A method according to claim 1 wherein said user addresses associated with said user include correspondent-specific user addresses each associated with a single correspondent.

34. A method according to claim 1 wherein said user addresses associated with said user include non-specific user addresses associated with a class of correspondents.

35. A method according to claim 1 wherein said user addresses associated with said user are not restricted as to correspondent.

36. A method of assignment of a source user address to an outgoing message from a user to a correspondent, including the steps of:
storing user data including a plurality of user addresses associated with said user, each said user address being further associated with one or more correspondents of said user;
reading recipient identification data associated with the outgoing message;
comparing said recipient identification data to said correspondents associated with user addresses of said user; and
upon finding a user address in said user data associated with both said user and the correspondent, inserting said user address as the source address for the outgoing message, or upon failing to find a user address in said user data associated with both said user and the correspondent, generating a new user address associated with both said user and the correspondent, inserting said new user address as the source address for the outgoing message and adding said new user address details to the user data.

37. A method according to claim 36 wherein said user data includes expiry dates for said user addresses.

38. A method according to claim 37 further including the step of extending an expiry date of a user address.

39. A method according to claim 37 further including the step of reviving a user address for which the expiry date has passed.

40. A computer processor adapted to perform a method according to claim 1.

41. A system including a plurality of computer processors, said computer processors including a mail server, verification server and user address assignment server, said computer processors together being configured to perform a method according to claim 1.

42. An electronic mail server including:
an interface for receiving an incoming electronic mail message to a user; and
a mail processor configured to extract sender identification data from said message and forward said extracted data to a verification server, to receive from the verification server an authorization code for the message and to tag said message with the authorization tag and transmit the message.

43. An electronic mail server according to claim 42 wherein said mail processor is further configured to extract user address data from said message and forward said extracted data to a verification server.

44. An electronic mail server including:
an interface for receiving an outgoing electronic mail message from a user; and
a mail processor configured to extract recipient identification data from said message and forward said extracted data to a user address assignment server, to receive from the user address assignment server a user address assigned to the message and to insert said assigned user address as a source address for said message and for forwarding the message.

45. A computer-readable medium having computer executable instructions stored therein for performing the steps of a method according to claim 1.

46. A computer-readable medium having stored thereon a user database storing associations between user addresses, users and correspondents for use in a method according to claim 1.

47. A system for delivery of electronic messages including one or more of the following:
means for classifying an incoming message according to claim 12;
means for assigning a user address to an outgoing message, said means being arranged to perform a method of assignment according to claim 36;
means for delaying delivery of an outgoing message;
means for cancelling delivery of an outgoing message;
means for selectively generating an outgoing message upon receiving an incoming message wherein said incoming messages matches one or more criteria specified by the user,
means for detecting an electronic message containing user-specified content,
means for generating an alerting message upon detecting a match between two or more on-line users,
means for analysing an electronic message based on its content, wherein said content includes an employment opportunity,
means for sending a SMS or similar message through a computer terminal,
means for replacing an e-mail attachment to an electronic message with a File Transfer Protocol Utility, said means inserting an URL into the electronic message,
means for penetrating user's security measures to detect and report security risks.

48. A system according to claim 47 further including means for automatically sending a mobile telephone message to a user upon sending an electronic mail message to said user.

49. A system according to claim 48 wherein said mobile telephone message is an SMS message.

50. A system according to claim 49 further including means for managing a SMS recipient list through a computer terminal.

51. A method for delivery of electronic message to an intended recipient including the steps of
delaying delivery of the electronic message,
notifying the intended recipient of the message,
prompting the recipient to reply in a specified manner,
upon receiving a reply in the specified manner, sending the message to the recipient, and
advising the sender.

52. A method according to claim 51 wherein said specified manner includes the step of sending a reply message having the same subject field.

53. A method for preventing delivery of electronic message including the steps of
making known a specified code to be used for preventing delivery of said electronic message,
receiving a first message, said first message being sent by a sender to a user address,
receiving a second message having a subject field, said second message being sent by the same sender to the same user address,
examining the subject field of said second message to ascertain the presence of said specified code,
upon detecting said specified code, comparing said first and said second messages,
upon detecting a match between said messages, preventing delivery of said messages,
advising the sender.

54. A method for managing a list of intended recipients including the steps of
storing a list of defunct user addresses of a user,
providing means for completing a communication request,
upon receiving said communication request, comparing said communication request to the stored defunct user address data,
upon detecting a match between said communication request and a said stored defunct user address, notifying the user of the communication request.

55. A method according to claim 5 wherein said mail server is a telephone switch in telephone communications.

56. A method according to claim 1 wherein said address is an e-mail address.

57. A method according to claim 1 wherein said address is a phone number.

58. A method according to claim 1 wherein said address is an internet protocol address.

59. A method according to claim 1 wherein said address is an instant messaging number.

60. A method of assigning a user address to a message having a real source address and a destination address associated with a correspondent including the steps of:
generating said user address based on one or more of the following: a reference to said user identification data; a reference to said correspondent identification data; a reference to identification data of a third party; a reference to an address of said user; a reference to an address of said correspondent; a reference to an address of a third party; a reference to a subject matter of a message; a pre-determined code known to said user; a pre-determined code known to said correspondent; a pre-determined code known to a third party; a random number; instructions on handling that message;
substituting said generated source address for said real source address.

61. A method of classifying an incoming message addressed to a user address of a user, said user address being generated according to claim 60, including the steps of
reading the user address associated with the incoming message,
reading sender identification data associated with the incoming message,
comparing said sender identification data to said user address to yield a comparison result, and
classifying, in response to said comparison result, the incoming message as a member of one of said pre-defined classes of messages.

62. A method according to claim 1 wherein said user address includes one or more of the following:
a reference to said user identification data;
a reference to said correspondent identification data;
a reference to identification data of a third party;
a reference to an address of said user;
a reference to an address of said correspondent;
a reference to an address of a third party;
a reference to a subject matter of a message;
a pre-determined code known to said user;
a pre-determined code known to said correspondent;
a pre-determined code known to a third party;
a random number;
instructions on handling that message.
